(19) United States
(12) Patent Application Publication
(10) Pub. No.: US 2013/0146441 A1
(43) Pub. Date: Jun. 13, 2013

(54) Method for producing a gas mixture of Hydrogen Ions and Hydroxide Ions

(71) Applicants: Tao-Wei WU, Taichung City (TW); Chih-Hsuan Wu, Henderson, NV (US)

(72) Inventors: Tao-Wei WU, Taichung City (TW); Chih-Hsuan Wu, Henderson, NV (US)

(21) Appl. No.: 13/531,647

(22) Filed: Jun. 25, 2012

(30) Foreign Application Priority Data
Dec. 7, 2011 (CN) CN 201110403136.3

(51) Int. Cl. C01B 3/02

(52) U.S. Cl. 204/164

(57) ABSTRACT

A method for producing a gas mixture of hydrogen ions and hydroxide ions in which the hydrogen ions and the hydroxide ions are maintained an ionic state and exist independently. The method comprises a pre-processing step, a splitting step, and a positive charging step.

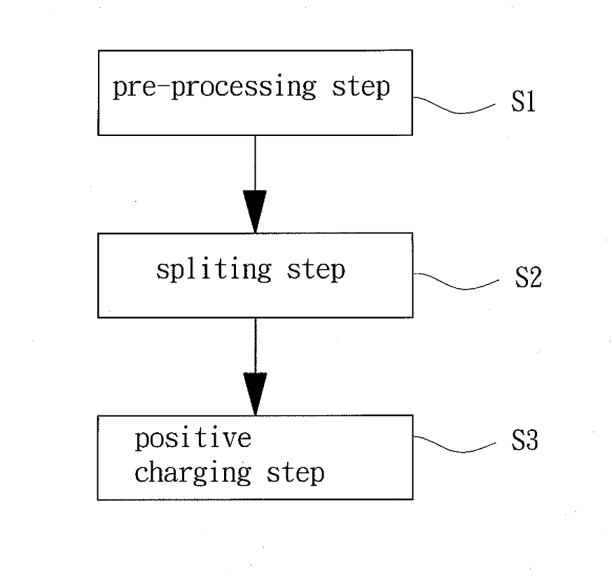

### BACKGROUND OF THE INVENTION

1. Field of the Invention

The present invention relates to a method for producing a gas mixture of hydrogen ions and hydroxide ions, and more particularly, to a method for producing a gas mixture of hydrogen ions and hydroxide ions in which the hydrogen ions and the hydroxide ions are maintained at ionic states and exist independently.

2. Description of the Related Art

Due to the fact that the outer radius of oxygen atoms are larger than that of hydrogen, it is commonly misunderstood that the hydrogen and oxygen are directly produced via splitting liquid water in conventional methods for producing hydrogen and oxygen from liquid water. In fact, combusting liquid water molecules at a high temperature will break the oxygen to hydrogen bonds (OH bonds) between hydrogen ions and hydroxide ions, and produce a gas mixture of hydrogen ions and hydroxide ions.

However, the hydrogen ions and hydroxide ions are easily apt to recover back to the stabilized water molecule state if the gas mixture of hydrogen ions and hydroxide ions are not subjected to a proper separation process. In the event of using such un-separated gas mixture of hydrogen and hydroxide may cause inestimable damages to equipment.

In China Patents, including CN200610126898.2, CN200410062479.8, and CN200910012966.6 disclose methods for combusting water through water splitting by producing a gas mixture of hydrogen and oxygen, also known as hydroxide flame. With the assistance of the gas mixture of hydrogen and oxygen, complete combustion of hydrocarbon and carbon monoxide can be achieved. However, under such methods OH bonds between the hydroxide ions in the gas mixture are prone to break even further if the excessive heat energy is absorbed instantaneously. Thus the methods for combusting water may create a high-oxygen environment and cause uncontrolled spontaneous combustion of hydrogen that may lead to explosion of the boiler.

In China Patents, CN02131308.3, CN02131309.1, and CN200910069848.9 for example, disclose methods for applying the producing hydrogen or gas mixture of hydrogen into an internal combustion engine; however, the risk of explosion caused by spontaneous combustion of hydrogen still exists, also, the said Patent include the misunderstanding that the products of splitting water are hydrogen and oxygen.

Therefore the above patents fail to provide solutions for independent existence of the hydrogen and hydroxide in ionic states. The OH bonds between hydrogen ions and hydroxide ions tend to recover to their stable condensed water state if the temperature of the environment is below dew point and the voltage difference is grounded. The condensed water is apt to react with the sulfur in fossil fuels inside combustion equipment such as internal combustion engines or boilers, thus generating large quantity of sulfate ions and sulfite in a short period of time and causing damage to the combustion equipments through acidification and corrosion.

Furthermore, the refused hydrogen molecules are apt to react with the steel parts of the internal combustion engines or boilers, causing corrosion of the steel parts. Over time, the internal combustion engines or boilers will not be able to provide the same level of performance. Taking internal combustion engines as an example, the internal pressure decreases as airtight parts corrode. When pressure decreases, incompletely combusted substances are produced and the thermal energy released by the fuel decreases. Thus the torque of the internal combustion engine is significantly reduced and the temperature of exhaust gas increases. The internal combustion engine is no longer efficient and performing at the optimal level.

Based on the listed scenarios a method for stabilizing the hydrogen ions and hydroxide ions in a gas mixture is needed for utilizing such mixture in combustion equipment.

### SUMMARY OF THE INVENTION

An objective of the present invention is to provide a method for producing a gas mixture of hydrogen ions and hydroxide ions, with the method, the hydrogen ions and the hydroxide ions are maintained their ionic state independently, avoiding generating hydrogen by a re-fusion of hydrogen ions and hydroxide ions, namely, recovering to water. Thus, a spontaneous combustion of hydrogen in a high-oxygen environment will be avoided.

Another objective of the present invention is to provide a method for producing a gas mixture of hydrogen ions and hydroxide ions, with the method, the hydrogen ions and the hydroxide ions can be applied in various combustion equipments to completely combust substances. Thus, complete combustion and increased torque of the combustion equipments and reduced exhaust gas temperature are achieved.

A further objective of the present invention is to provide a method for producing a gas mixture of hydrogen ions and hydroxide ions, with the method, the liquid water molecules at water surface will be nanolized, so that the heat of the exhaust gas is able to be recovered at room temperature. Thus a low energy-consuming water splitting is achieved.

### BRIEF DESCRIPTION OF THE DRAWING

SOLE FIGURE shows a block diagram illustrating a method for producing a gas mixture of hydrogen ions and hydroxide ions according to the preferable embodiment of the present invention.

### DETAILED DESCRIPTION OF THE INVENTION

The drawing illustrates a preferred example of a method for producing a gas mixture of hydrogen ions and hydroxide ions according to the present invention. The method includes a pre-processing step S1, a splitting step S2, and a positive charging step S3. It is appreciated that the present invention can be accomplished through the splitting step S2 and the positive charging step S3 to easily split water molecules into hydrogen ions and hydroxide ions that can exist independently in their ionic state. Thus, the pre-processing step S1 can optionally be carried out according to the choice of an operator. Nevertheless, in the preferred example, the pre-processing step S1 is preferably carried out before the splitting step S2 and the positive charging step S3 in terms of low energy consumption and high efficiency.

The term “pyrolysis energy” referred to herein means any energy (such as electricity, heat energy, chemical energy, etc) that can break the OH bonds in the liquid water molecules. The term “constant high voltage” referred to herein means any voltage value capable of outputting free electrons carrying sufficient positive charges to disturb the hydroxide ions after water splitting. Other conditions and limitations of the pyrolysis energy and the constant high voltage will be set forth more specifically in the detailed description of each step.

In the pre-processing step S1, liquid water molecules are impacted by a low-pressure/high-frequency oscillation, to atomize superficial water molecules adjacent to the water surface and generate nanolized liquid water molecules. Specifically, the low-pressure/high-frequency oscillator (such as a sonic oscillator, a water-atomization oscillator, etc) is used to generate continuous high-frequency oscillation, conducting an oscillation of superficial water molecules adjacent to the water surface, and nanolizing liquid water molecules till approaching to the ionization of the water molecules, namely, with particulates radius of liquid water molecules being in a range of 20-1000 nm. While the liquid water molecules approaches ionization, the surface tension of the water molecule decreases dramatically. Thus, the volume of the water molecules instantly increases by multiple times, and the ionized water molecules will escape from the water surface and vapor in the state of a fog. Therefore, the ionized water molecules rapidly turn from the unsaturated state into the saturated state in a normal-temperature (about 18-78 degree C.) environment, so that a separated water molecule can be carried out in the subsequent splitting step S2 with less consumed energy. With such arrangement, the energy loss will be effectively reduced.

As an example, a water-atomization oscillator is mounted in an atomization tank that is filled with pure water. With high-frequency wave of the water-atomization, the water-atomization atomizes the superficial water molecules adjacent to the water surface and nanolizes the water molecules into particles having a diameter no larger than 300 nm. Thus, the water molecule particles drift upward into a spiral guiding tube.

Due to the centrifugal force acting on the water molecules flowing in the guiding tube, larger particles of water molecules rapidly condense into water drops that drip back into the atomization tank under the action of gravitational force. At the same time, smaller particles of water molecules are guided into a pyrolysis reaction tank in which the splitting step S2 undergoes. The water level of the liquid water in the atomization tank is preferably in a range corresponding to the operative band of the sound waves of the water-atomization oscillator, and more preferably in a range of 5-8 cm, such that the superficial water molecules adjacent to the water surface can easily be atomized into nanometer-scale particulates of liquid water molecules.

In the splitting step S2 the pyrolysis energy breaks the OH bonds between hydrogen ions and hydroxide ions in liquid water molecules, so that the hydrogen ions are able to escape from their orbit, obtaining a gas mixture of hydrogen ions and hydroxide ions through water splitting. The splitting step S2 can be processed by any pyrolysis approach or mechanism, such as high-frequency arc, Wi-max, high temperature heat exchanger, Nd—Fe—B magnet chest, etc. With continuously outputting pyrolysis energy to break the said OH bonds in liquid water molecules, it generates the gas mixture of hydrogen ions and hydroxide ions, with the hydrogen ions carrying positive charges and with the hydroxide ion carrying negative charges. The pyrolysis approach or mechanism for outputting pyrolysis energy is known in the art and, thus, not set forth in detail to avoid redundancy. An example of the pyrolysis approach or mechanism will be set forth hereinafter to more specifically describe the present invention. However, the present invention is covered but not limited to this example only.

The nanolized water molecules obtained from the pre-processing step S1 are guided into the pyrolysis reaction tank in which pyrolysis energy is sent out to split water molecules in a low-temperature environment, such as 350 degree C. which is below the self ignition temperature of hydrogen. Thus, the nanolized liquid water molecules will rapidly turn from the unsaturated state into the saturated state, breaking the OH bonds between hydrogen ions and hydroxide ions in the liquid water molecules during an isentropic pyrolysis procedure, with the hydrogen ions escaping from their orbits. More specifically, the water molecule particles are guided into an exhaust side of an exhaust gas turbo-charger.

The gas mixture of hydrogen ions and hydroxide ions can be generated by absorbing the remaining heat of the exhaust gas of the exhaust gas turbo-charger through a steel heat-exchanger mounted at the output end of the exhaust gas turbo-charger. The hydrogen ions in the gas mixture carry positive charges, and the hydroxide ions in the gas mixture carry negative charges. To obtain a better effect, the voltage creating the arc is preferably 110V, and the voltage of the Wi-max is preferably 380V.

In the positive charging step S3, free electrons carrying positive charges are loaded by a constant high voltage into the gas mixture. The free electrons disturb the hydroxide ions carrying negative charges, turning the hydroxide ions carrying negative charges into hydroxide ions carrying positive charges so as to be repulsive to the hydrogen ions carrying positive charges. Thus, the hydrogen ions and the hydroxide ions can exist independently.

The constant high voltage can be released by point discharge to load more than 10⁸ free electrons per second per cubic meter, particularly for alternating current having a voltage of 1926V and a current of 1A. With the alternating current being in the form of square waveforms, and with the frequency of the alternating current being between 20-2400 Hz, to load a large amount of free electrons carrying positive charges into the gas mixture through application of a constant high voltage is achieved.

Since the positive charges carried by the free electrons are larger than the positive charges of the hydrogen ions after water splitting, when the free electrons are carrying positive charges in contact with the hydroxide ions the free electrons disturb the hydroxide ions carrying negative charges. Thus the hydroxide ions carry negative charges turned into hydroxide ions carrying positive charges after filling the free electrons, and the hydrogen ions and the hydroxide ions will have the same polarity (both carrying positive charges).

Due to existence of voltage difference of the same polarity, the hydrogen ions and the hydroxide ions can exist independently without contacting the other water molecules or without contacting groundable chemical compounds in the passage to the combustion chambers. Thus, re-formation of liquid water molecules resulting from re-fusion of the hydrogen ions and the hydroxide ions is avoided. Namely, avoiding recovering to water in any chance.

As a result, the hydrogen ions and the hydroxide ions can be used in various combustion equipments, such as internal combustion engines, boilers, fuel cells . . . etc, to avoid spontaneous combustion of hydrogen in a high-oxygen environment and to supply the combustion equipments with the gas mixture of hydrogen ions and hydroxide ions at time the gas mixture is produced. Therefore, the incompletely combusted substances, such as PM carbon, hydrocarbons, carbon monoxide, carbon dioxide, are able to be combusted completely. Reducing suspending particulates in the combustion equipments, increasing the output of kinetic energy, and increasing the torque, and reducing the exhaust gas temperature and reducing the Nitrogen Oxides are achieved at the same time.

In an example, the constant high voltage is obtained by point discharge of a high-density carbon filament (or graphite brush). Meanwhile, the free electrons are loaded by the constant high voltage into the gas mixture. The free electrons carrying nanolized Carbon ions and positive charges are emitted into the gas mixture at an output end of the heat-exchanger. The constant high voltage is preferably a 12V direct current converted by a DC/AC converting circuit (such as an inverter, a converter, etc) into a 1926V alternating current with square waveforms. The alternating frequency controlling the square waveforms is in a range of 60-120 Hz. The constant high voltage loads about 10⁸ free electrons per second per cubic meter into the gas mixture. Since the free electrons disturb the hydroxide ions carrying negative charges, the hydrogen ions carry positive charges while the hydroxide ions carrying positive charges are filled by the free electrons. Thus, the hydrogen ions and the hydroxide electrons both carrying positive charges are repulsive to each other such that a voltage difference due to the same polarity always exists between the hydrogen ions and the hydroxide ions.

The technique of converting a direct current by an DC/AC converting circuit (such as an inverter, a converter, etc) into an alternating current is known in the art and is merely one of many options of application of the constant high voltage of the present invention. Detailed description of such a technique is not given to avoid redundancy. However, the present invention is not limited to this technique. Furthermore, the value of positive charges of the hydroxide ions after filling of the voids by the electrons is decided by the potential of the free electrons loaded by the constant high voltage (i.e., the higher the potential of the free electrons, the higher the value of positive charges of the hydroxide ions after filling), which is known in the art and is practicable. No examples and further description will be set forth.

In view of the foregoing, after changing the liquid water into the nanolized water molecules by the pre-processing step S1, the splitting step S2 is carried out to break the OH bonds between hydrogen ions and hydroxide ions in liquid water molecules to generate a gas mixture of hydrogen ions and hydroxide ions after water splitting. Of more importance, the gas mixture is subjected to the positive charging step S3 that uses free electrons to turn the hydroxide ions carrying negative charges into hydroxide ions carrying positive charges so as to be repulsive to the hydrogen ions carrying positive charges, finally obtaining hydrogen ions and hydroxide ions that exist independently in an ionic state. Operation of the method of the present invention can be expressed by the following equations.

H₂O+e⁺→OH⁻+e⁺+H⁺═OH⁺H⁺

e⁺=1.60217646×10⁻¹⁹ J, OH⁻<e⁺

Thus, by obtaining a gas mixture independently existing hydrogen ions and hydroxide ions, the present invention can be widely used in various combustion equipments, such as internal combustion engines, boilers, etc. Application of the present invention in an internal combustion engine can now be set forth by way of example.

In another example of producing the gas mixture, a water chamber (i.e., the pyrolysis reaction tank) is filled with a 14% aqueous solution of sodium hydroxide. Steel plates are placed in the water chamber. The two electrodes are applied with a voltage of DC 12V and a current of DC 1 A, generating hydroxide ion gas at the anode and generating hydrogen ion gas at the cathode. The gas mixture of hydrogen ions and the hydroxide ions are guided into a water/gas separator. Free electrons are supplied into the gas mixture at an outlet of the water/gas separator so that the free electrons move freely in the gas mixture in a mixing tube behind the outlet of the water/gas separator. The gas mixture including free electrons passes through a capillary tube (the feeding direction of the gas mixture is parallel to the airflow direction of an inlet manifold) or a low-speed high-pressure venturi tube.

After controlling the flow by a flow-adjusting screw, the low-pressure gas mixture of hydrogen ions and hydroxide ions is sucked into a turbo-charger and then into the inlet manifold. At this time, the gas mixture can be smoothly guided into an internal combustion engine, and the ratio of the gas mixture to air is controlled in a range of 0.4-3%. The concentration of the hydrogen ions and hydroxide ions is increased due to high compression ratio in the internal combustion engine.

In the environment including high concentration of hydrogen ions and hydroxide ions, the combustion speed resulting from self ignition of hydrogen ions is higher than the effect provided by octane and hexadecane and the auxiliary combustion effect provided by the hydroxide ions, increasing the combustion speed of the gas mixture and assisting complete combustion of the fossil fuels through the high combustion speed. Sufficient heat energy of alkaline is released in the combustion chamber of the internal combustion engine, increasing the torque and reducing the exhaust gas temperature. To maintain the low-emission/high-efficiency combustion effect, a closed loop effect can be obtained through signal output of exhaust temperature sensors and oxygen sensors mounted in the exhaust pipe and through control of an electronic control unit (ECU).

Thus, the combustion speed can be increased by the hydrogen ions and hydroxide ions to completely combust substances such as carbon, hydrocarbons, carbon monoxide, carbon dioxide, etc. The torque is also increased to reduce the power demand (including high energy consumption and high emission) of a loaded vehicle that moves uphill, starts to move, or is gathering speed. The fuel loss can be reduced and the service life can be prolonged through use of sensors at the accelerator pedal and air inlet sensors as well as the control by the electronic control unit. The temperature of the exhaust gas is reduced, and the emission of nitrogen oxides of the loaded vehicle is reduced, achieving development of industries while protecting the environment.

The main feature of the method for producing a gas mixture of hydrogen ions and hydroxide ions is that through loading of a large amount of free electrons carrying positive charges by the constant high voltage, the free electrons provide disturbance to turn the hydroxide ions carrying negative charges into hydroxide ions carrying positive charges so as to be repulsive to the hydrogen ions carrying positive charges. Furthermore, the recovery of the OH bonds of the hydrogen ions and hydroxide ions is avoided by the voltage difference between the hydrogen ions and hydroxide ions having the same polarity. Thus, the hydrogen ions and hydroxide ions can exist independently in ionic state.

When applying the hydrogen ions and hydroxide ions produced from the method according to the present invention in various combustion equipments such as internal combustion engines or boilers, generation of condensed water resulting from re-fusion of the hydrogen ions and hydroxide ions is avoided, preventing acidification and corrosion of the combustion equipments (such as internal combustion engines or boilers) by sulfate ions and sulfite ions resulting from reaction of the condensed water and sulfur in fossil fuels. Furthermore, generation of the hydrogen molecules produced after re-fusion is also avoided, preventing hydrogen acid corrosion of the steel parts of the internal combustion engines or boilers due to reaction of the hydrogen molecules and with the steel parts. Thus, by using the hydrogen ions and hydroxide ions produced from the method according to the present invention, the internal combustion engines or boilers can provide better efficacy after a long period of use.

Taking an internal combustion engine as an example, the combustion effect of fossil fuels can be increased such that the large amount of incompletely combusted substances accumulated in the internal combustion chamber can completely be combusted to release sufficient heat energy of alkane, increasing the torque and reducing the exhaust gas temperature. Thus, the internal combustion engine can fulfill the power demand of vehicles in cases of high energy consumption and high emission.

Furthermore, by oscillating liquid water with the low-pressure/high-frequency technique, the superficial water molecules adjacent to the water surface can be atomized into nanometer-scale particulates of liquid water molecules. Through rapid transition of the water molecules approaching ionization from unsaturated steam into saturated steam, the liquid water molecules split into hydrogen ions and hydroxide ions in a low-temperature environment during an isentropic pyrolysis procedure. The energy required for splitting water molecules is reduced, cutting the costs and shortening the pyrolysis time of the water molecules to improve the operational efficiency.

In view of the forgoing, the method for producing a gas mixture of hydrogen ions and hydroxide ions according to the present invention allows independent existence of the hydrogen ions and hydroxide ions to avoid re-fusion of the hydrogen ions and hydroxide ions and to avoid self ignition of the hydrogen ions in a high-oxygen environment. Furthermore, the method for producing a gas mixture of hydrogen ions and hydroxide ions according to the present invention can be used in various combustion equipments to completely combust the incompletely combusted substances (such as carbon, hydrocarbons, monoxide, etc) in the combustion equipments to increase the torque and to reduce the exhaust gas temperature.

Further, the method for producing a gas mixture of hydrogen ions and hydroxide ions according to the present invention can firstly turn the liquid water molecules into nanometer-scale particulates of water molecules such that splitting water molecules can be accomplished in a low-temperature environment in a subsequent step, reducing the energy required for splitting water molecules.

What is claimed is:

1. A method for producing a gas mixture of hydrogen ions and hydroxide ions comprising:
a splitting step, with the splitting step breaking oxygen to hydrogen bonds between hydrogen ions and hydroxide ions in liquid water molecules, causing hydrogen ions to escape from their orbits, generating the gas mixture of hydrogen ions and hydroxide ions; and
a positive charging step, with the positive charging step loading free electrons carrying positive charges into the gas mixture by a constant high voltage, with the free electrons disturbing the hydroxide ions carrying negative charges and turning the hydroxide ions carrying negative charges into hydroxide ions carrying positive charges,
wherein, the hydroxide ions carrying positive charges repulsive to the hydrogen ions carrying positive charges, with the hydrogen ions and the hydroxide ions existing independently in an ionic state.

2. The method for producing the gas mixture of hydrogen ions and hydroxide ions as claimed in claim 1, further comprising a pre-processing step before the splitting step, with the pre-processing step including impacting the liquid water molecules by low-pressure high-frequency oscillation, causing atomization of superficial water molecules adjacent to a water surface, generating nanolized liquid water molecules.

3. The method for producing the gas mixture of hydrogen ions and hydroxide ions as claimed in claim 2, with the pre-processing step including producing continuous high-frequency oscillation by a low-pressure/high-frequency oscillator to cause the superficial water molecules to approach ionization, with the nanolized liquid water molecules having a diameter of 20-1000 nm.

4. The method for producing the gas mixture of hydrogen ions and hydroxide ions as claimed in claim 1, with the positive charging step including releasing the constant high voltage by point discharge using a high-density carbon filament.

5. The method for producing the gas mixture of hydrogen ions and hydroxide ions as claimed in claim 1, with the constant high voltage being obtained by transforming a 12V direct current by a DC/AC converting circuit into a 1926V alternating current and then outputting the constant high voltage from the 1926V alternating current.

6. The method for producing the gas mixture of hydrogen ions and hydroxide ions as claimed in claim 1, with the positive charging step including releasing the constant high voltage by outputting an alternating current to load more than 10⁸ free electrons per second per cubic meter into the gas mixture.

7. The method for producing the gas mixture of hydrogen ions and hydroxide ions as claimed in claim 6, with the constant high voltage outputted by the alternating current having a voltage of 1926V and a current of 1 A having square waveforms, and with the alternating current having a frequency between 20-2400 Hz.

8. The method for producing the gas mixture of hydrogen ions and hydroxide ions as claimed in claim 1, with the splitting step including continuously sending out a pyrolysis energy by high-frequency plasma generated by an 110V direct current with square waveforms or by Wi-max having a radio frequency voltage of 380V.
